(19) United States
(12) Patent Application Publication
(10) Pub. No.: US 2025/0216737 A1
(43) Pub. Date: Jul. 3, 2025

(54) ELECTROPHORETIC MEDIA COMPRISING A CATIONIC CHARGE CONTROL AGENT

(71) Applicant: E INK CORPORATION, Billerica, MA (US)

(72) Inventors: Eugene BZOWEJ, Dunstable, MA (US); Darwin Scott BULL, Harvard, MA (US)

(21) Appl. No.: 18/991,994

(22) Filed: Dec. 23, 2024

Related U.S. Application Data
(60) Provisional application No. 63/616,957, filed on Jan. 2, 2024.

(51) Int. Cl. G02F 1/167; C09K 9/02; G02F 1/1675; G02F 1/16757; G02F 1/1681

(52) U.S. Cl. CPC G02F 1/167; C09K 9/02; G02F 1/16757; G02F 1/1681; C09K 2211/1003; G02F 2001/1678

(57) ABSTRACT

Electrophoretic media are disclosed containing a plurality of charged pigment particles, a charge control agent, and a non-polar liquid. The molecular structure of the charge control agent includes two quaternary ammonium functional groups, two or more amide functional groups or two or more ester functional groups, and two or more aliphatic biradical units, each of the two or more aliphatic biradical units comprising a ring structure.

### RELATED APPLICATIONS

This application claims priority to U.S. Provisional Patent Application No. 63/616,957 filed on Jan. 2, 2024, which is incorporated by reference in its entirety, along with all other patents and patent applications disclosed herein.

### FIELD OF THE INVENTION

This invention relates to electrophoretic media for electro-optic devices, the electrophoretic media comprising a plurality of charged pigment particles and a cationic charge control agent in a non-polar liquid. The molecular structure of the charge control agent includes two quaternary ammonium functional groups, two or more amide functional groups or two or more ester functional groups, and two or more aliphatic biradical units, each of the two or more aliphatic biradical units comprising a ring structure.

### BACKGROUND OF THE INVENTION

The term “electro-optic”, as applied to a material or a display, is used herein in its conventional meaning in the imaging art to refer to a material having first and second display states differing in at least one optical property, the material being changed from its first to its second display state by application of an electric field to the material. Although the optical property is typically color perceptible to the human eye, it may be another optical property, such as optical transmission, reflectance, luminescence or, in the case of displays intended for machine reading, pseudo-color in the sense of a change in reflectance of electromagnetic wavelengths outside the visible range.

Particle-based electrophoretic displays have been the subject ofintense research and development for a number of years. In such displays, a plurality of charged pigment particles (sometimes referred to as charged particles or pigment particles) move through a fluid under the influence of an electric field. The electric field is typically provided by a conductive film or a transistor, such as a field-effect transistor. Electrophoretic displays have good brightness and contrast, wide viewing angles, state bistability, and low power consumption when compared with liquid crystal displays. Such electrophoretic displays have slower switching speeds than LCD displays, however, and electrophoretic displays are typically too slow to display real-time video. Additionally, the electrophoretic displays can be sluggish at low temperatures because the viscosity of the fluid limits the movement of the charged pigment particles. Despite these shortcomings, electrophoretic displays can be found in everyday products such as electronic books (e-readers), mobile phones and mobile phone covers, smart cards, signs, watches, shelf labels, and flash drives.

The term “gray state” is used herein in its conventional meaning in the imaging art to refer to a state intermediate two extreme optical states of a pixel and does not necessarily imply a black-white transition between these two extreme states. For example, several of the E Ink patents and published applications referred to below describe electrophoretic displays in which the extreme states are white and deep blue, so that an intermediate “gray state” would be pale blue. Indeed, as already mentioned, the change in optical state may not be a color change at all. The terms “black” and “white” may be used hereinafter to refer to the two extreme optical states of a display and should be understood as normally including extreme optical states which are not strictly black and white, for example the aforementioned white and dark blue states. The term “monochrome” may be used hereinafter to denote a drive scheme which only drives pixels to their two extreme optical states with no intervening gray states.

Many commercial electrophoretic media essentially display only two colors, with a gradient between the black and white extremes, known as “grayscale”. Such electrophoretic media either use a single type of electrophoretic particle having a first color in a colored fluid having a second, different color, or first and second types of charged pigment particles having different first and second colors in an uncolored fluid. In the former case, the first color is displayed when the charged pigment particles lie adjacent the viewing surface of the display and the second color is displayed when the charged pigment particles are spaced from the viewing surface. In the latter case, the first color is displayed when the first type of charged pigment particles lie adjacent the viewing surface of the display and the second color is displayed when the second type of charged pigment particles lie adjacent the viewing surface. Typically, the two colors are black and white.

Some electro-optic materials are solid in the sense that the materials have solid external surfaces, although the materials may, and often do, have internal liquid- or gas-filled spaces. Such displays using solid electro-optic materials may hereinafter for convenience be referred to as “solid electro-optic displays”. Thus, the term “solid electro-optic displays” includes rotating bichromal member displays, encapsulated electrophoretic displays, microcell electrophoretic displays and encapsulated liquid crystal displays.

The terms “bistable” and “bistability” are used herein in their conventional meaning in the art to refer to displays comprising display elements having first and second display states differing in at least one optical property, and such that after any given element has been driven, by means of an addressing pulse of finite duration, to assume either its first or second display state, after the addressing pulse has terminated, that state will persist for at least several times, for example at least four times, the minimum duration of the addressing pulse required to change the state of the display element. It is shown in U.S. Pat. No. 7,170,670 that some particle-based electrophoretic displays capable of gray scale are stable not only in their extreme black and white states but also in their intermediate gray states, and the same is true of some other types of electro-optic displays. This type of display is properly called “multi-stable” rather than bistable, although for convenience the term “bistable” may be used herein to cover both bistable and multi-stable displays.

One type of electro-optic display, which has been the subject of intense research and development for a number of years, is the particle-based electrophoretic display, in which a plurality of charged pigment particles move through a fluid under the influence of an electric field. Electrophoretic displays can have attributes of good brightness and contrast, wide viewing angles, state bistability, and low power consumption when compared with liquid crystal displays. Nevertheless, problems with the long-term image quality of these displays have prevented their widespread usage. For example, charged pigment particles that make up electrophoretic displays tend to settle, resulting in inadequate service-life for these displays.

Numerous patents and applications assigned to or in the names of the Massachusetts Institute of Technology (MIT), E Ink Corporation, E Ink California, LLC. and related companies describe various technologies used in encapsulated and microcell electrophoretic and other electro-optic media. Encapsulated electrophoretic media comprise numerous small capsules, each of which itself comprises an electrophoretic medium containing electrophoretically-mobile pigment particles in a fluid medium, and a capsule wall surrounding the electrophoretic medium. Typically, the capsules are themselves held within a polymeric binder to form a coherent layer positioned between two electrodes. In a microcell electrophoretic display, the charged pigment particles and the fluid are not encapsulated within microcapsules but instead are retained within a plurality of cavities formed within a carrier medium, typically a polymeric film. [[Hereinafter, the term “microcavity electrophoretic display” may be used to cover both encapsulated and microcell electrophoretic displays.]] The technologies described in these patents and applications include:
(a) Electrophoretic particles, fluids and fluid additives; see for example U.S. Pat. Nos. 5,961,804; 6,017,584; 6,120,588; 6,120,839; 6,262,706; 6,262,833; 6,300,932; 6,323,989; 6,377,387; 6,515,649; 6,538,801; 6,580,545; 6,652,075; 6,693,620; 6,721,083; 6,727,881; 6,822,782; 6,831,771; 6,870,661; 6,927,892; 6,956,690; 6,958,849; 7,002,728; 7,038,655; 7,052,766; 7,110,162; 7,113,323; 7,141,688; 7,142,351; 7,170,670; 7,226,550; 7,230,750; 7,230,751; 7,236,290; 7,277,218; 7,286,279; 7,312,916; 7,382,514; 7,390,901; 7,473,782; 7,561,324; 7,583,251; 7,572,394; 7,576,904; 7,580,180; 7,679,814; 7,848,006; 7,903,319; 8,018,640; 8,115,729; 8,257,614; 8,270,064; 8,363,306; 8,390,918; 8,582,196; 8,654,436; 8,902,491; 8,961,831; 9,052,564; 9,341,915; 9,348,193; 9,361,836; 9,366,935; 9,372,380; 9,382,427; 9,423,666; 9,428,649; 9,557,623; 9,670,367; 9,671,667; 9,688,859; 9,726,957; 9,752,034; 9,765,015; 9,778,535; 9,778,537; 9,835,926; 9,953,588; 9,995,987; 10,025,157; 10,031,394; 10,040,954; 10,061,123; 10,062,337; 10,147,366; and 10,514,583; and U.S. Patent Application Publication Nos. 2003/0048522; 2003/0151029; 2003/0164480; 2004/0030125; 2004/0105036; 2005/0012980; 2009/0009852; 2011/0217639; 2012/0049125; 2013/0161565; 2013/0193385; 2013/0244149; 2013/0063333; 2014/0011913; 2014/0078576; 2014/0104674; 2014/0231728; 2015/0177590; 2015/0185509; 2015/0241754; 2015/0301425; and 2016/0170106;
(b) Capsules, binders and encapsulation processes; see for example U.S. Pat. Nos. 5,930,026; 6,067,185; 6,130,774; 6,262,706; 6,327,072; 6,392,786; 6,459,418; 6,727,881, 6,839,158; 6,866,760; 6,922,276; 6,958,848; 6,987,603; 7,110,164; 7,148,128; 7,184,197; 7,304,634; 7,327,511, 7,339,715; 7,411,719; 7,477,444; 7,561,324; 7,910,175; 7,952,790; 8,129,655; 8,446,664; and U.S. Patent Applications Publication Nos. 2005/0156340; 2007/0091417; and 2009/0122389;
(c) Microcell structures, wall materials, and methods of forming microcells; see for example U.S. Pat. Nos. 6,672,921; 6,751,007; 6,753,067; 6,781,745; 6,788,452; 6,795,229; 6,806,995; 6,829,078; 6,850,355; 6,865,012; 6,870,662; 6,885,495; 6,930,818; 6,933,098; 6,947,202; 7,046,228; 7,072,095; 7,079,303; 7,141,279; 7,156,945; 7,205,355; 7,233,429; 7,261,920; 7,271,947; 7,304,780; 7,307,778; 7,327,346; 7,347,957; 7,470,386; 7,504,050; 7,580,180; 7,715,087; 7,767,126; 7,880,958; 8,002,948; 8,154,790; 8,169,690; 8,441,432; 8,891,156; 9,279,906; 9,291,872; 9,388,307; 9,436,057; 9,436,058; 9,470,917; 9,919,553; and 10,401,668; and U.S. Patent Applications Publication Nos. 2003/0203101; 2014/0050814; and 2016/0059442;
(d) Methods for filling and sealing microcells; see for example U.S. Pat. Nos. 6,545,797; 6,788,449; 6,831,770; 6,833,943; 6,930,818; 7,046,228; 7,052,571; 7,166,182; 7,347,957; 7,374,634; 7,385,751; 7,408,696; 7,557,981; 7,560,004; 7,564,614; 7,572,491; 7,616,374; 7,715,087; 7,715,088; 8,361,356; 8,625,188; 8,830,561; 9,346,987; and 9,759,978; and U.S. Patent Applications Publication Nos. 2002/0188053; 2004/0120024; 2004/0219306; and 2015/0098124;
(e) Films and sub-assemblies containing electro-optic materials; see for example U.S. Pat. Nos. 6,825,829; 6,982,178; 7,110,164; 7,158,282; 7,554,712; 7,561,324; 7,649,666; 7,728,811; 7,826,129; 7,839,564; 7,843,621; 7,843,624; 7,952,790; 8,034,209; 8,177,942; 8,390,301; 9,238,340; 9,470,950; 9,835,925; and U.S. Patent Applications Publication Nos. 2005/0122563; 2007/0237962; and 2011/0164301;
(f) Backplanes, adhesive layers and other auxiliary layers and methods used in displays; see for example U.S. Pat. Nos. D485,294; 5,930,026; 6,120,588; 6,124,851; 6,177,921; 6,232,950; 6,252,564; 6,312,304; 6,312,971; 6,376,828; 6,392,786; 6,413,790; 6,480,182; 6,498,114; 6,506,438; 6,518,949; 6,545,291; 6,639,578; 6,657,772; 6,664,944; 6,683,333; 6,710,540; 6,724,519; 6,816,147; 6,819,471; 6,825,068; 6,831,769; 6,842,279; 6,842,657; 6,865,010; 6,873,452; 6,909,532; 6,967,640; 7,012,600; 7,012,735; 7,030,412; 7,075,703; 7,106,296; 7,110,163; 7,116,318; 7,148,128; 7,167,155; 7,173,752; 7,176,880; 7,190,008; 7,206,119; 7,223,672; 7,230,751; 7,256,766; 7,259,744; 7,301,693; 7,304,780; 7,327,346; 7,327,511; 7,347,957; 7,365,733; 7,388,572; 7,401,758; 7,492,497; 7,535,624; 7,551,346; 7,554,712; 7,560,004; 7,583,427; 7,649,674; 7,667,886; 7,672,040; 7,688,497; 7,826,129; 7,830,592; 7,839,564; 7,880,958; 7,893,435; 7,905,977; 7,952,790; 7,986,450; 8,034,209; 8,049,947; 8,072,675; 8,120,836; 8,159,636; 8,177,942; 8,237,892; 8,362,488; 8,395,836; 8,437,069; 8,441,414; 8,456,589; 8,514,168; 8,547,628; 8,576,162; 8,610,988; 8,714,780; 8,743,077; 8,754,859; 8,797,258; 8,797,633; 8,797,636; 9,147,364; 9,025,234; 9,025,238; 9,030,374; 9,140,952; 9,201,279; 9,223,164; 9,238,340; 9,285,648; 9,454,057; 9,529,240; 9,620,066; 9,632,373; 9,666,142; 9,671,635; 9,715,155; 9,777,201; 9,897,891; 10,037,735; 10,190,743; 10,324,577; 10,365,533; 10,372,008; 10,446,585; 10,466,565; 10,495,941; 10,503,041; 10,509,294; 10,613,407; and U.S. Patent Applications Publication Nos. 2002/0060321; 2004/0085619; 2004/0105036; 2005/0122306; 2005/0122563; 2006/0255322; 2009/0122389; 2010/0177396; 2011/0164301; 2011/0292319; 2014/0192000; 2014/0210701; 2014/0368753; and 2016/0077375; and International Application Publication Nos. WO2000/038000; WO2000/005704; and WO1999/067678;
(g) Color formation and color adjustment; see for example U.S. Pat. Nos. 6,017,584; 6,545,797; 6,664,944; 6,788,452; 6,864,875; 6,914,714; 6,972,893; 7,038,656; 7,038,670; 7,046,228; 7,052,571; 7,075,502; 7,167,155; 7,385,751; 7,492,505; 7,667,684; 7,684,108; 7,791,789; 7,800,813; 7,821,702; 7,839,564; 7,910,175; 7,952,790; 7,956,841; 7,982,941; 8,040,594; 8,054,526; 8,098,418; 8,159,636; 8,213,076; 8,363,299; 8,422,116; 8,441,714; 8,441,716; 8,466,852; 8,503,063; 8,576,470; 8,576,475; 8,593,721; 8,605,354; 8,649,084; 8,670,174; 8,704,756; 8,717,664; 8,786,935; 8,797,634; 8,810,899; 8,830,559; 8,873,129; 8,902,153; 8,902,491; 8,917,439; 8,964,282; 9,013,783; 9,116,412; 9,146,439; 9,164,207; 9,170,467; 9,170,468; 9,182,646; 9,195,111; 9,199,441; 9,268,191; 9,285,649; 9,293,511; 9,341,916; 9,360,733; 9,361,836; 9,383,623; and 9,423,666; and U.S. Patent Applications Publication Nos. 2008/0043318; 2008/0048970; 2009/0225398; 2010/0156780; 2011/0043543; 2012/0326957; 2013/0242378; 2013/0278995; 2014/0055840; 2014/0078576; 2014/0340430; 2014/0340736; 2014/0362213; 2015/0103394; 2015/0118390; 2015/0124345; 2015/0198858; 2015/0234250; 2015/0268531; 2015/0301246; 2016/0011484; 2016/0026062; 2016/0048054; 2016/0116816; 2016/0116818; and 2016/0140909;
(h) Methods for driving displays; see for example U.S. Pat. Nos. 5,930,026; 6,445,489; 6,504,524; 6,512,354; 6,531,997; 6,753,999; 6,825,970; 6,900,851; 6,995,550; 7,012,600; 7,023,420; 7,034,783; 7,061,166; 7,061,662; 7,116,466; 7,119,772; 7,177,066; 7,193,625; 7,202,847; 7,242,514; 7,259,744; 7,304,787; 7,312,794; 7,327,511; 7,408,699; 7,453,445; 7,492,339; 7,528,822; 7,545,358; 7,583,251; 7,602,374; 7,612,760; 7,679,599; 7,679,813; 7,683,606; 7,688,297; 7,729,039; 7,733,311; 7,733,335; 7,787,169; 7,859,742; 7,952,557; 7,956,841; 7,982,479; 7,999,787; 8,077,141; 8,125,501; 8,139,050; 8,174,490; 8,243,013; 8,274,472; 8,289,250; 8,300,006; 8,305,341; 8,314,784; 8,373,649; 8,384,658; 8,456,414; 8,462,102; 8,514,168; 8,537,105; 8,558,783; 8,558,785; 8,558,786; 8,558,855; 8,576,164; 8,576,259; 8,593,396; 8,605,032; 8,643,595; 8,665,206; 8,681,191; 8,730,153; 8,810,525; 8,928,562; 8,928,641; 8,976,444; 9,013,394; 9,019,197; 9,019,198; 9,019,318; 9,082,352; 9,171,508; 9,218,773; 9,224,338; 9,224,342; 9,224,344; 9,230,492; 9,251,736; 9,262,973; 9,269,311; 9,299,294; 9,373,289; 9,390,066; 9,390,661; and 9,412,314; and U.S. Patent Applications Publication Nos. 2003/0102858; 2004/0246562; 2005/0253777; 2007/0091418; 2007/0103427; 2007/0176912; 2008/0024429; 2008/0024482; 2008/0136774; 2008/0291129; 2008/0303780; 2009/0174651; 2009/0195568; 2009/0322721; 2010/0194733; 2010/0194789; 2010/0220121; 2010/0265561; 2010/0283804; 2011/0063314; 2011/0175875; 2011/0193840; 2011/0193841; 2011/0199671; 2011/0221740; 2012/0001957; 2012/0098740; 2013/0063333; 2013/0194250; 2013/0249782; 2013/0321278; 2014/0009817; 2014/0085355; 2014/0204012; 2014/0218277; 2014/0240210; 2014/0240373; 2014/0253425; 2014/0292830; 2014/0293398; 2014/0333685; 2014/0340734; 2015/0070744; 2015/0097877; 2015/0109283; 2015/0213749; 2015/0213765; 2015/0221257; 2015/0262255; 2015/0262551; 2016/0071465; 2016/0078820; 2016/0093253; 2016/0140910; and 2016/0180777;
(i) Applications of displays; see for example U.S. Pat. Nos. 6,118,426; 6,473,072; 6,704,133; 6,710,540; 6,738,050; 6,825,829; 7,030,854; 7,119,759; 7,312,784; 7,705,824; 8,009,348; 8,011,592; 8,064,962; 8,162,212; 8,553,012; 8,973,837; 9,188,829; and 9,197,704; and U.S. Patent Applications Publication Nos. 2002/0090980; 2004/0119681; 2007/0285385; 2013/0176288; 2013/0221112; 2013/0233930; 2013/0235536; 2014/0049808; 2014/0062391; 2014/0206292; and 2016/0035291; and International Application Publication No. WO 00/36560; and
(j) Non-electrophoretic displays, as described in U.S. Pat. Nos. 6,241,921; 6,784,953; 6,795,138; 6,914,713; 6,950,220; 7,095,477; 7,182,830; 7,245,414; 7,420,549; 7,471,369; 7,576,904; 7,580,180; 7,850,867; 8,018,643; 8,023,071; 8,282,762; 8,319,759; and 8,994,705 and U.S. Patent Applications Publication Nos. 2005/0099575; 2006/0262249; 2007/0042135; 2007/0153360; 2008/0020007; 2012/0293858; and 2015/0277160; and applications of encapsulation and microcell technology other than displays; see for example U.S. Pat. No. 7,615,325; and U.S. Patent Application Publications Nos. 2015/0005720 and 2016/0012710.

Although electrophoretic media are often opaque (since, for example, in many electrophoretic media, the charged pigment particles substantially block transmission of visible light through the display) and operate in a reflective mode, many electrophoretic displays can be made to operate in a so-called “shutter mode” in which one display state is substantially opaque and one is light-transmissive. See, for example, U.S. Pat. Nos. 5,872,552; 6,130,774; 6,144,361; 6,172,798; 6,271,823; 6,225,971; and 6,184,856. Dielectrophoretic displays, which are similar to electrophoretic displays but rely upon variations in electric field strength, can operate in a similar mode; see U.S. Pat. No. 4,418,346. Other types of electro-optic displays may also be capable of operating in shutter mode. Electro-optic media operating in shutter mode may be useful in multi-layer structures for full color displays; in such structures, at least one layer adjacent the viewing surface of the display operates in shutter mode to expose or conceal a second layer more distant from the viewing surface.

An encapsulated electrophoretic display typically does not suffer from the clustering and settling failure mode of traditional electrophoretic devices and provides further advantages, such as the ability to print or coat the display on a wide variety of flexible and rigid substrates. (Use of the word “printing” is intended to include all forms of printing and coating, including, but without limitation: pre-metered coatings such as patch die coating, slot or extrusion coating, slide or cascade coating, curtain coating; roll coating such as knife over roll coating, forward and reverse roll coating; gravure coating; dip coating; spray coating; meniscus coating; spin coating; brush coating; air knife coating; silk screen printing processes; electrostatic printing processes; thermal printing processes; ink jet printing processes; electrophoretic deposition (See U.S. Pat. No. 7,339,715); and other similar techniques.) Thus, the resulting display can be flexible. Further, because the display medium can be printed (using a variety of methods), the display itself can be made inexpensively.

An electrophoretic display normally comprises a layer of electrophoretic material and at least two other layers disposed on opposed sides of the electrophoretic material, one of these two layers being an electrode layer. In most such displays both the layers are electrode layers, and one or both of the electrode layers are patterned to define the pixels of the display. For example, one electrode layer may be patterned into elongate row electrodes and the other into elongate column electrodes running at right angles to the row electrodes, the pixels being defined by the intersections of the row and column electrodes. Alternatively, and more commonly, one electrode layer has the form of a single continuous electrode, and the other electrode layer is patterned into a matrix of pixel electrodes, each of which defines one pixel of the display. In another type of electrophoretic display, which is intended for use with a stylus, print head or similar movable electrode separate from the display, only one of the layers adjacent the electrophoretic layer comprises an electrode, the layer on the opposed side of the electrophoretic layer typically being a protective layer intended to prevent the movable electrode damaging the electrophoretic layer.

The manufacture of a three-layer electrophoretic display normally involves at least one lamination operation. For example, in several of the aforementioned MIT and E Ink patents and applications, there is described a process for manufacturing an encapsulated electrophoretic display in which an encapsulated electrophoretic medium comprising capsules in a binder is coated on to a flexible substrate comprising indium-tin-oxide (ITO) or a similar conductive coating (which acts as one electrode of the final display) on a plastic film, the capsules/binder coating being dried to form a coherent layer of the electrophoretic medium firmly adhered to the substrate. Separately, a backplane, containing an array of pixel electrodes and an appropriate arrangement of conductors to connect the pixel electrodes to drive circuitry, is prepared. To form the final display, the substrate having the capsule/binder layer thereon is laminated to the backplane using a lamination adhesive. (A very similar process can be used to prepare an electrophoretic display usable with a stylus or similar movable electrode by replacing the backplane with a simple protective layer, such as a plastic film, over which the stylus or other movable electrode can slide.) In one preferred form of such a process, the backplane is itself flexible and is prepared by printing the pixel electrodes and conductors on a plastic film or other flexible substrate. The obvious lamination technique for mass production of displays by this process is roll lamination using a lamination adhesive.

As discussed in the aforementioned U.S. Pat. No. 6,982,178, (see column 3, line 63 to column 5, line 46) many of the components used in electrophoretic displays, and the methods used to manufacture such displays, are derived from technology used in liquid crystal displays (LCD's). For example, electrophoretic displays may make use of an active matrix backplane comprising an array of transistors or diodes and a corresponding array of pixel electrodes, and a “continuous” front electrode (in the sense of an electrode which extends over multiple pixels and typically the whole display) on a transparent substrate, these components being essentially the same as in LCD's. However, the methods used for assembling LCDs cannot be used with encapsulated electrophoretic displays. LCDs are normally assembled by forming the backplane and front electrode on separate glass substrates, then adhesively securing these components together leaving a small aperture between them, placing the resultant assembly under vacuum, and immersing the assembly in a bath of the liquid crystal, so that the liquid crystal flows through the aperture between the backplane and the front electrode. Finally, with the liquid crystal in place, the aperture is sealed to provide the final display.

This LCD assembly process cannot readily be transferred to encapsulated displays. Because the electrophoretic material is solid, it must be present between the backplane and the front electrode before these two integers are secured to each other. Furthermore, in contrast to a liquid crystal material, which is simply placed between the front electrode and the backplane without being attached to either, an encapsulated electrophoretic medium normally needs to be secured to both; in most cases the electrophoretic medium is formed on the front electrode, since this is generally easier than forming the medium on the circuitry-containing backplane, and the front electrode/electrophoretic medium combination is then laminated to the backplane, typically by covering the entire surface of the electrophoretic medium with an adhesive and laminating under heat, pressure and possibly vacuum. Accordingly, most prior art methods for final lamination of solid electrophoretic displays are essentially batch methods in which (typically) the electro-optic medium, a lamination adhesive and a backplane are brought together immediately prior to final assembly, and it is desirable to provide methods better adapted for mass production.

Electro-optic displays, including electrophoretic displays, can be costly; for example, the cost of the color LCD found in a portable computer is typically a substantial fraction of the entire cost of the computer. As the use of such displays spreads to devices, such as cellular telephones and personal digital assistants (PDA's), much less costly than portable computers, there is great pressure to reduce the costs of such displays. The ability to form layers of electrophoretic media by printing techniques on flexible substrates, as discussed above, opens the possibility of reducing the cost of electrophoretic components of displays by using mass production techniques such as roll-to-roll coating using commercial equipment used for the production of coated papers, polymeric films and similar media.

An electro-optic display normally comprises a layer of electro-optic material and at least two other layers disposed on opposed sides of the electro-optic material, one of these two layers being an electrode layer. In most such displays both the layers are electrode layers, and one or both of the electrode layers are patterned to define the pixels of the display. For example, one electrode layer may be patterned into elongate row electrodes and the other into elongate column electrodes running at right angles to the row electrodes, the pixels being defined by the intersections of the row and column electrodes. Alternatively, and more commonly, one electrode layer has the form of a single continuous electrode, and the other electrode layer is patterned into a matrix of pixel electrodes, each of which defines one pixel of the display. In another type of electro-optic display, which is intended for use with a stylus, print head or similar movable electrode separate from the display, only one of the layers adjacent the electro-optic layer comprises an electrode, the layer on the opposed side of the electro-optic layer typically being a protective layer intended to prevent the movable electrode damaging the electro-optic layer.

The aforementioned U.S. Pat. No. 6,982,178 describes a method of assembling a solid electro-optic display (including an encapsulated electrophoretic display) which is well adapted for mass production. Essentially, this patent describes a so-called “front plane laminate” (“FPL”) which comprises, in order, a light-transmissive electrically-conductive layer; a layer of a solid electro-optic medium in electrical contact with the electrically-conductive layer; an adhesive layer; and a release sheet. Typically, the light-transmissive electrically-conductive layer will be carried on a light-transmissive substrate, which is preferably flexible, in the sense that the substrate can be manually wrapped around a drum (say) 10 inches (254 mm) in diameter without permanent deformation. The term “light-transmissive” is used in this patent and herein to mean that the layer thus designated transmits sufficient light to enable an observer, looking through that layer, to observe the change in display states of the electro-optic medium, which will normally be viewed through the electrically-conductive layer and adjacent substrate (if present); in cases where the electro-optic medium displays a change in reflectivity at non-visible wavelengths, the term “light-transmissive” should of course be interpreted to refer to transmission of the relevant non-visible wavelengths. The substrate will typically be a polymeric film and will normally have a thickness in the range of about 1 to about 25 mil (25 to 634 μm), preferably about 2 to about 10 mil (51 to 254 μm). The electrically-conductive layer is conveniently a thin metal or metal oxide layer of, for example, aluminum or ITO, or may be a conductive polymer. Poly(ethylene terephthalate) (PET) films coated with aluminum or ITO are available commercially, for example as “aluminized Mylar” (“Mylar” is a Registered Trademark) from E.I. du Pont de Nemours & Company, Wilmington DE, and such commercial materials may be used with good results in the front plane laminate.

Assembly of an electro-optic display using such a front plane laminate may be effected by removing the release sheet from the front plane laminate and contacting the adhesive layer with the backplane under conditions effective to cause the adhesive layer to adhere to the backplane, thereby securing the adhesive layer, layer of electro-optic medium and electrically-conductive layer to the backplane. This process is well-adapted to mass production since the front plane laminate may be mass produced, typically using roll-to-roll coating techniques, and then cut into pieces of any size needed for use with specific backplanes.

U.S. Pat. No. 7,561,324 describes a so-called “double release sheet” which is essentially a simplified version of the front plane laminate of the aforementioned U.S. Pat. No. 6,982,178. One form of the double release sheet comprises a layer of a solid electro-optic medium sandwiched between two adhesive layers, one or both of the adhesive layers being covered by a release sheet. Another form of the double release sheet comprises a layer of a solid electro-optic medium sandwiched between two release sheets. Both forms of the double release film are intended for use in a process generally similar to the process for assembling an electro-optic display from a front plane laminate already described, but involving two separate laminations; typically, in a first lamination the double release sheet is laminated to a front electrode to form a front sub-assembly, and then in a second lamination the front sub-assembly is laminated to a backplane to form the final display, although the order of these two laminations could be reversed if desired.

U.S. Pat. No. 7,839,564 describes a so-called “inverted front plane laminate”, which is a variant of the front plane laminate described in the aforementioned U.S. Pat. No. 6,982,178. This inverted front plane laminate comprises, in order, at least one of a light-transmissive protective layer and a light-transmissive electrically-conductive layer; an adhesive layer; a layer of a solid electro-optic medium; and a release sheet. This inverted front plane laminate is used to form an electro-optic display having a layer of lamination adhesive between the electro-optic layer and the front electrode or front substrate; a second, typically thin layer of adhesive may or may not be present between the electro-optic layer and a backplane. Such electro-optic displays can combine good resolution with good low temperature performance.

Light modulators represent a potentially important market for electro-optic media. As the energy performance of buildings and vehicles becomes increasingly important, electro-optic media can be used as coatings on windows (including skylights and sunroofs) to enable the proportion of incident radiation transmitted through the windows to be electronically controlled by varying the optical state of the electro-optic media. Effective implementation of such “variable-transmissivity” (“VT”) technology in buildings is expected to provide (1) reduction of unwanted heating effects during hot weather, thus reducing the amount of energy needed for cooling, the size of air conditioning plants, and peak electricity demand; (2) increased use of natural daylight, thus reducing energy used for lighting and peak electricity demand; and (3) increased occupant comfort by increasing both thermal and visual comfort. Even greater benefits would be expected to accrue in an automobile, where the ratio of glazed surface to enclosed volume is significantly larger than in a typical building. Specifically, effective implementation of VT technology in automobiles is expected to provide not only the aforementioned benefits but also (1) increased motoring safety, (2) reduced glare, (3) enhanced mirror performance (by using an electro-optic coating on the mirror), and (4) increased ability to use heads-up displays. Other potential applications of VT technology include privacy glass and glare-guards in electronic devices.

If a full color display is desired, a color filter array may be deposited over the viewing surface of the monochrome (black and white) display. Displays with color filter arrays rely on area sharing and color blending to create color stimuli. The available display area is shared between three or four primary colors such as red/green/blue (RGB) or red/green/blue/white (RGBW), and the filters can be arranged in one-dimensional (stripe) or two-dimensional (2×2) repeat patterns. Other choices of primary colors or more than three primaries are also known in the art. The three (in the case of RGB displays) or four (in the case of RGBW displays) sub-pixels are chosen to be small enough, so that at the intended viewing distance they visually blend together to a single pixel with a uniform color stimulus (‘color blending’). The inherent disadvantage of area sharing is that the colorants are always present, and colors can only be modulated by switching the corresponding pixels of the underlying monochrome display to white or black (switching the corresponding primary colors on or off). For example, in an ideal RGBW display, each of the red, green, blue, and white primaries occupy one fourth of the display area (one sub-pixel out of four), with the white sub-pixel being as bright as the underlying monochrome display white, and each of the colored sub-pixels being no lighter than one third of the monochrome display white. The brightness of the white color shown by the display as a whole cannot be more than one half of the brightness of the white sub-pixel. This is caused by the fact that white areas of the display are produced by displaying the one white sub-pixel out of each four, plus each colored sub-pixel in its colored form being equivalent to one third of a white sub-pixel. Thus, the three colored sub-pixels combined contribute no more than the one white sub-pixel. The brightness and saturation of colors is lowered by area-sharing with color pixels switched to black. Area sharing is especially problematic when mixing yellow because it is lighter than any other color of equal brightness, and saturated yellow is almost as bright as white. Switching the blue pixels (one fourth of the display area) to black makes the yellow too dark.

A full color display may alternatively be provided by using an electrophoretic media containing multiple colored charged pigment particles having varying electrophoretic mobility. For example, U.S. Pat. No. 9,921,451 teaches a colored electrophoretic display that includes an electrophoretic medium which comprises (a) one type of light-scattering charged pigment particles (typically white) and (b) three substantially non-light-scattering types of charged pigment particles providing three subtractive primary colors. The use of substantially non-light-scattering particle types having subtractive primary colors allows mixing of colors and provides for more color outcomes at a single pixel than can be achieved with a color filter. Electrophoretic media and electrophoretic devices display complex behaviors, particularly those containing multiple set of charged pigments with varying charges and mobility. An important aspect of the operation of the display is the interaction of the charge control agent with the charged pigment particles. The charge control agent modifies the surface charge of the charged pigment particles, which enables the selective movement of the charged pigment particles under the influence of an applied electric field. Furthermore, charge control agents also contribute to the stabilization of charged pigment particles in terms of particle aggregation. Charge control agents are surfactant-type polymeric molecules having one or more polar functional groups (head groups) and hydrophobic functional groups (tails). Charge control agents are able to form reverse micelles in the electrophoretic medium of the display, wherein the head groups are positioned towards the more polar core of the inverse micelle and the tails are positioned towards the more non-polar outside surface of the inverse micelle and in direct contact with the non-polar liquid of the electrophoretic medium. Given the structure of typical charge control agents and their function, it is likely that there are three physical features of charge control agents that are responsible for their effectiveness, such as hydrophobicity, charge, and hydrogen bond capability. The charge control agent should be reasonably soluble in the non-polar liquid of the electrophoretic medium. A commonly used charge control agent has a quaternary ammonium functional group head and a polyester tail, the polyester tail being formed via polymerization reaction of fatty hydroxy carboxylic acid monomers, such as 12-hydroxystearic acid or an unsaturated hydroxycarboxylic acid monomer. The inventors of the present invention surprisingly found that electrophoretic media comprising a cationic charge control agent, the molecular structure of which includes two quaternary ammonium functional groups, two or more amide functional groups or two or more ester functional groups, and two or more aliphatic biradical units, each of the two or more aliphatic biradical units comprising a ring structure provide improved electro-optic performance in comparison to a charge control agent comprising a commonly used cationic charge control agent that comprises a linear hydrophobic tail.

### SUMMARY OF THE INVENTION

In one aspect, the present invention provides an electrophoretic medium comprising a plurality of charged pigment particles, a charge control agent, and a non-polar liquid, the charge control agent having a molecular structure including two or more quaternary ammonium functional groups, two or more amide functional groups or two or more ester functional groups, and two or more aliphatic biradical units, each or the two or more aliphatic biradical units comprising a ring structure. Each of the two or more aliphatic biradical units may contain from 28 to 40 carbon atoms. The ring structure may comprise a six-member ring. The six-member ring may comprise a double bond. The six-member ring may comprise only carbon-carbon single bonds. The six-member ring may have four aliphatic substituents. A substituent of the six-member ring may be an alkenyl group.

Each of the two or more aliphatic biradical units may be selected from the group consisting of molecular structures that are represented by Formula I and Formula II.

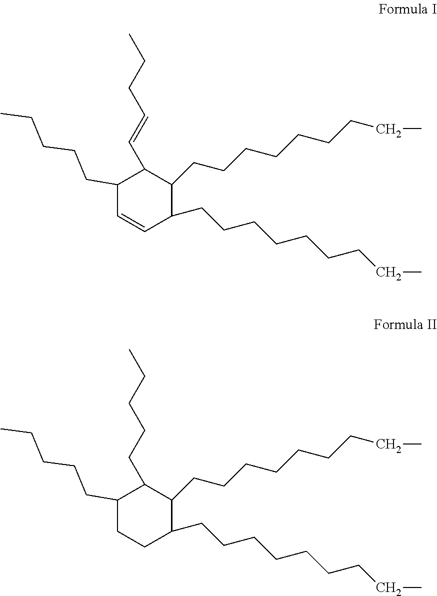

The molecular structure of the charge control agent may comprise a group that is represented by Formula III, wherein each Q is independently selected from the group consisting of oxygen and NH group, wherein each —Z— is independently selected from the group consisting of an aliphatic biradical unit -A- and an aliphatic biradical unit —B—, -A- being represented by Formula I, and —B— being represented by Formula II, and wherein r is an integer from 1 to 20.

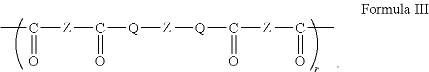

The molecular structure of the charge control agent may be represented by Formula IV, wherein R1, R2, and R3 are independently selected by the group consisting of an alkyl, aryl, and alkenyl group, wherein each Q is independently selected from the group consisting of oxygen and NH group, wherein each —Z— is independently selected from the group consisting of an aliphatic biradical unit -A- and an aliphatic biradical unit —B—, -A- being represented by Formula I, and —B— being represented by Formula II, and wherein r is an integer from 1 to 20.

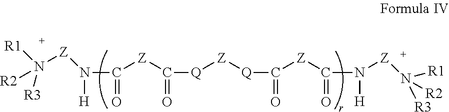

The molecular structure of the charge control agent may be represented by Formula V, wherein R1, R2, and R3 are independently selected by the group consisting of alkyl, aryl, and alkenyl group, wherein each Q is independently selected from the group consisting of oxygen, and NH group, wherein each G is independently selected from the group consisting of oxygen, sulfur, and NH group, wherein D is —(CH₂)ₜ—, where t is an integer from 3 to 6, wherein each —Z— is independently selected from the group consisting of an aliphatic biradical unit -A- and an aliphatic biradical unit —B—, -A- being represented by Formula I, and —B— being represented by Formula II, and wherein r is an integer from 1 to 20.

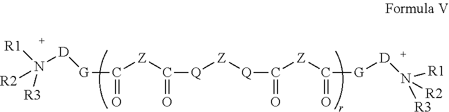

The molecular structure of the charge control agent may be represented by Formula V, wherein R1, R2, R3 are methyl, G is oxygen or NH, Q is oxygen, D is —(CH₂)₃—, and —Z— is an aliphatic biradical unit that is represented by Formula I or Formula II. The molecular structure of the charge control agent may be represented by Formula V, wherein R1, R2, R3 are methyl, G is oxygen or NH, and —Z— is an aliphatic biradical unit that is represented by Formula I. The molecular structure of the charge control agent may be represented by Formula V, wherein R1, R2, R3 are methyl, G is NH, and —Z— is an aliphatic biradical unit that is represented by Formula I.

The molecular structure of the charge control agent may be represented by Formula VI, wherein R1, R2, and R3 are independently selected by the group consisting of alkyl, aryl, and alkenyl group, wherein each Q is independently selected from the group consisting of oxygen and NH group, wherein each —Z— is independently selected from the group consisting of an aliphatic biradical unit -A- and an aliphatic biradical unit —B—, -A- being represented by Formula I, and —B— being represented by Formula II, and wherein r is an integer from 1 to 20.

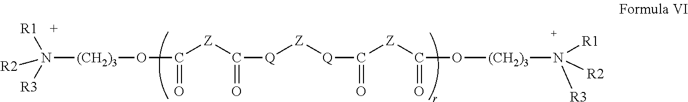

The charge control agent may have a weight average molecular weight greater than or equal to 1000 g/mol or from 1000 g/mol to 8,000 g/mol.

The electrophoretic medium of the present invention may also comprise a second charge control agent. The second charge control agent may comprise a hydrophobic moiety and a head group selected from the group comprising an anionic functional group, a nonionic functional group, and a cationic functional group.

The plurality of charged pigment particles may be capable of moving through the non-polar liquid upon application of an electric field.

The electrophoretic medium of the present invention may comprise a plurality of first, second, and third types of charged pigment particles, wherein each type of charged pigment particles has different color from each other type of charged pigment particles. The plurality of charged pigment particles are capable of moving through the non-polar liquid upon application of an electric field. The electrophoretic medium of the present invention may further comprise a plurality of fourth type of charged pigment particles, each of the plurality of fourth type of charged pigment particles having different color from each particle from the pluralities of first, second and third type of charged pigment particles. Each particle of the plurality of the first and second types of charged pigment particles may have a negative charge, whereas each particle of the plurality of the third and fourth types of charged pigment particles may have a positive charge. Each particle of the plurality of first type of charged pigment particles may have a first charge polarity, whereas each particle of the plurality of the second, third and fourth types of charged pigment particles may have a second charge polarity, the second charge polarity being opposite from the first charge polarity.

In another aspect, the present invention provides an electro-optic display comprising a light transmissive, electrically-conductive layer, an electro-optic material layer, and a substrate comprising a plurality of pixel electrodes. The electro-optic material layer comprises an electrophoretic medium comprising a plurality of charged pigment particles, a charge control agent, and a non-polar liquid, the charge control agent having a molecular structure including two quaternary ammonium functional groups, two or more amide functional groups or two or more ester functional groups, and two or more aliphatic biradical units, each of the two aliphatic biradical units comprising a ring structure. Each of the two or more aliphatic biradical units may contain from 28 to 40 carbon atoms. The ring structure may comprise a six-member ring. The six-member ring may comprise a double bond. The six-member ring may comprise only carbon-carbon single bonds. The six-member ring may have four aliphatic substituents. A substituent of the six-member ring may be an alkenyl group. Each of the two or more aliphatic biradical units may be independently selected from the group consisting of molecular structures that are represented by Formula I and Formula II.

The molecular structure of the charge control agent may comprise a group that is represented by Formula III, wherein each Q is independently selected from the group consisting of oxygen and NH group, wherein each —Z— is independently selected from the group consisting of an aliphatic biradical unit -A- and an aliphatic biradical unit —B—, -A- being represented by Formula I, and —B— being represented by Formula II, and wherein r is an integer from 1 to 20. The molecular structure of the charge control agent may be represented by Formula IV, wherein R1, R2, and R3 are independently selected by the group consisting of an alkyl, aryl, and alkenyl group, wherein each Q is independently selected from the group consisting of oxygen and NH group, wherein each —Z— is independently selected from the group consisting of an aliphatic biradical unit -A- and an aliphatic biradical unit —B—, -A- being represented by Formula I, and —B— being represented by Formula II, and wherein r is an integer from 1 to 20. The molecular structure of the charge control agent may be represented by Formula V, wherein R1, R2, and R3 are independently selected by the group consisting of alkyl, aryl, and alkenyl group, wherein each Q is independently selected from the group consisting of oxygen, and NH group, wherein each G is independently selected from the group consisting of oxygen, sulfur, and NH group, wherein D is —(CH₂)ₜ—, where t is an integer from 3 to 6, wherein each —Z— is independently selected from the group consisting of an aliphatic biradical unit -A- and an aliphatic biradical unit —B—, -A- being represented by Formula I, and —B— being represented by Formula II, and wherein r is an integer from 1 to 20. The electrophoretic medium of the electro-optic display may be encapsulated in a plurality of microcapsules or in a plurality of microcells. The plurality of microcells includes a bottom layer, partition walls, an opening, and a sealing layer, the sealing layer spanning the opening of each microcell.

### BRIEF DESCRIPTION OF DRAWINGS

FIG. 1 is a side view of a color electro-optic display comprising electrophoretic medium encapsulated in microcapsules. The color electrophoretic display comprises, in order, a first electrode layer, an electro-optic material layer, a first adhesive layer, and a second electrode layer.

FIG. 2 is a side view of a color electro-optic display comprising electrophoretic medium encapsulated in microcapsules. The color electrophoretic display comprises, in order, a first electrode layer, a second adhesive layer, an electro-optic material layer, a first adhesive layer, and a second electrode layer.

FIG. 3 is a side view of a color electro-optic display comprising electrophoretic medium encapsulated in microcells. The color electrophoretic display comprises, in order, a first electrode layer, an electro-optic material layer including a sealing layer, a first adhesive layer, and a second electrode layer.

FIG. 4 is a graph of the color gamut of an electro-optic display that comprises an inventive electrophoretic medium and a graph of the color gamut of an electro-optic display that comprises a comparative electrophoretic medium.

### DETAILED DESCRIPTION OF THE INVENTION

In the following detailed description, numerous specific details are set forth by way of examples to provide a thorough understanding of the relevant teachings. However, it should be apparent to those skilled in the art that the present teachings may be practiced without such details.

The present invention provides electrophoretic media comprising charged pigment particles, a charge control agent, and a non-polar liquid. A particle that absorbs, scatters, or reflects light, either in a broad band or at selected wavelengths, is referred to herein as a colored or pigment particle. The electrophoretic media may be incorporated into displays, or into front plane laminates or inverted front plane laminates, front plane laminates and inverted front plane laminates being coupled to a backplane to form a display.

As used herein, “head group” of a molecule that comprises both a hydrophilic and hydrophobic part is the functional group of the hydrophilic part of the molecule. The molecule may have one group or more than one head groups.

The term “molecular weight” or “MW” as used herein refers to the weight average molecular weight, unless otherwise stated. The weight average molecular weight is measured by gel permeation chromatography.

The term “aliphatic biradical unit”, as used herein, is a molecular structure, which is part of a larger molecule, wherein the molecular structure of the biradical unit has two or more terminal atoms, each of the two or more terminal atoms being bonded to another molecular fragment or functional group to form a larger molecule. That is, the larger molecule that contains the “aliphatic biradical unit”, such as the charge control agent in this instance, does not contain a single electron species (reactive free radicals). For example, the literature occasionally refers to an ethylene group —CH₂CH₂— (or a methylene group —CH₂—) as a biradical, even if it is part of a molecule such as ethylene chloride (Cl—CH₂CH₂—Cl), which does not contain any radicals at its non-excited state. In the case of biradical units that are represented by Formula I and Formula II, the terminal atoms of the biradical units are carbon atoms (part of the terminal —CH₂— groups).

An “amide functional group” can be represented by formula —N—C(O)— and “an ester functional group” is represented by formula —O—C(O)—, both including a carbonyl group (—C═O).

The electrophoretic media according to the various embodiments of the present invention comprises a plurality of charged pigment particles, a charge control agent, and a non-polar liquid. The charge control agent has a molecular structure that includes two or more quaternary ammonium functional groups, two or more amide functional groups or two or more ester functional groups, and two or more aliphatic biradical units, each of the two or more aliphatic biradical unit comprising a ring structure. Each of the two or more aliphatic biradical units may contain from 28 to 40 carbon atoms

The ring structure may comprise a six-member ring. The six-member ring may comprise a double bond. The six-member ring may comprise only carbon-carbon single bonds. The six-member ring may contain a double bond. The six-member ring may have four aliphatic substituents. Each of the two or more aliphatic biradical units may be a molecular structure that is represented by Formula I or Formula II.

The molecular structure of the charge control agent may comprise one or more group that is represented by Formula III. In Formula III, each Q is independently selected from the group consisting of oxygen and NH group, each —Z— is independently selected from the group consisting of an aliphatic biradical unit -A- and an aliphatic biradical unit —B—, -A- being represented by Formula I, and —B— being represented by Formula II. In Formula III, r may be an integer from 1 to 20. In Formula II, r may be an integer from 1 to 18, from 2 to 16, from 2 to 14, from 3 to 20, from 4 to 18, from 5 to 16, or from 5 to 14. The oxygen is divalent (—O—). The NH group is also divalent (—N(H)—).

The molecular structure of the charge control agent may be represented by Formula IV. In Formula IV, R1, R2, and R3 are independently selected by the group consisting of an alkyl, aryl, and alkenyl group, each Q is independently selected from the group consisting of oxygen and NH group, each group —Z— of Formula IV is independently selected from the group consisting of an aliphatic biradical unit -A- and an aliphatic biradical unit —B—, -A- being represented by Formula I, and —B— being represented by Formula II, and r may be an integer from 1 to 20. In Formula IV, r may be an integer from 1 to 18, from 2 to 16, from 2 to 14, from 3 to 20, from 4 to 18, from 5 to 16, or from 5 to 14.

The molecular structure of the charge control agent may be represented by Formula V. In Formula V, R1, R2, and R3 are independently selected by the group consisting of alkyl, aryl, and alkenyl group, each Q is independently selected from the group consisting of oxygen and NH group, each G is independently selected from the group consisting of oxygen, sulfur, and NH group, D is —(CH₂)ₜ—, where t is an integer from 3 to 6, each —Z— of Formula V is independently selected from the group consisting of an aliphatic biradical unit -A- and an aliphatic biradical unit —B—, -A- being represented by Formula I, and —B— being represented by Formula II, and r is an integer from 1 to 20. In Formula V, r may be an integer from 1 to 18, from 2 to 16, from 2 to 14, from 3 to 20, from 4 to 18, from 5 to 16, or from 5 to 14. In Formula V, t may be an integer from 3 to 6, from 3 to 5, or from 3 to 4. In Formula V, t may be 3, 4, 5, or 6. The oxygen and sulfur are divalent (—O—; —S—). The NH group is also divalent (—N(H)—).

The molecular structure of the charge control agent may be represented by Formula VI. In Formula VI, R1, R2, and R3 are independently selected by the group consisting of alkyl, aryl, and alkenyl group, each Q is independently selected from the group consisting of oxygen and NH group, each group —Z— of Formula VI is independently selected from the group consisting of an aliphatic biradical unit -A- and an aliphatic biradical unit —B—, -A- being represented by Formula I, and —B— being represented by Formula II, and r is an integer from 1 to 20. In Formula VI, r may be an integer from 1 to 18, from 2 to 16, from 2 to 14, from 3 to 20, from 4 to 18, from 5 to 16, or from 5 to 14.

The charge control agent may have a weight average molecular weight greater than or equal to 500 g/mol, 1000 g/mol, 2000 g/mol, or 3000 g/mol. The charge control agent may have a weight average molecular weight from 500 g/mol to 10000 g/mol, from 1000 g/mol to 9000 g/mol, from 1000 g/mol to 8000 g/mol, from 1500 g/mol to 8000 g/mol, from 2000 g/mol to 7000 g/mol, or from 2000 g/mol to 6000 g/mol.

Commercial materials that are important for the formation of the charge control agents of the present invention are commercially available from Cargill under the commercial codes Pripol™ Priamine™, and Priplast™. Specifically, Cargill supplies (a) dimer carboxylic acids HOOC-A-COOH, HOOC—B—COOH, (b) dimer amines H₂N-A-NH₂, H₂N—B—HN₂, (c) dimer alcohols HO-A-OH, HO—B—OH, and (d) polyesters, which are formed by dimer polyacids and dimer alcohols, where -A- is the biradical that is represented by Formula I and —B— is the biradical that is represented by Formula II. These dimer products of high purity are prepared commercially as the Diels-Alder adducts of Tall oil fatty acids. These commercial products provide a very useful platform to manufacture condensation polymers having controlled hydrophobicity, charge, and hydrogen bonding by varying the molecular weight, conversion of primary amine to quaternary amine, and ratio of ester to amide. As such, they are useful as charge control agents. That is, the structure of the polymer can be tailored to achieve optimal balance of hydrophobicity, charge and hydrogen-bonding for a given set of pigments that are used in color electro-optic displays. This, in turn, allows more precise control of pigment aggregation. An additional potential benefit of dimer-based charge control agents is that the high level of branching may lead to improved low-temperature performance. The charge control agent that is formed may have two or more amide functional groups or two or more ester functional groups. That is, the charge control agent may have two, three, four, five, or more amide functional groups or ester functional groups. Amide groups are useful, because they can form hydrogen bonds with polar functional groups that are present on the surface of pigment particles, which may increase the effectiveness of the charge control agent for controlling the particle charge and the aggregation stability of the particles. On the other hand, if the number of amide groups of the charge control agent is large, its solubility in the non-polar liquid of the electrophoretic medium may be reduced, affecting its effectiveness.

The dimer carboxylic acid and the dimer amine (or the dimer alcohol) can react via condensation reaction to form an oligomer or polymer comprising amide bonds (or ester bonds). The dimer carboxylic acid may react with a mixture of a dimer amine and a dimer alcohol via condensation reaction to form an oligomer or polymer comprising both amide bonds and ester bonds. Depending on the stoichiometry of the reaction, the oligomer or oligomer may contain terminal amine functional groups or terminal carboxylic functional groups. In the case of oligomers or polymers that contain terminal amine functional groups, two or more of the terminal amine functional groups can be converted to two or more quaternary ammonium functional groups after reaction with alkylating agents in one or more than one steps. The quaternary ammonium functional groups may contain substituents that have one or more carbon-carbon double bonds, depending on the alkylating agent that is used. The cationic polymers that are produced by the processes described above have a molecular structure that can be generally represented by Formula IV.

Another approach for forming charge control agents with improved performance is utilizing structures having carboxylic acid terminated oligomers or polymers. Specifically, as discussed above, the stoichiometry of the reaction between dimer carboxylic acid and dimer amine (or the dimer alcohol, or mixtures of dimer amine and dimer alcohol) can be controlled to form oligomers or polymers containing terminal carboxyl functional groups. Two or more of the carboxylic functional groups of the oligomer or polymer may be further reacted with a reagent, the reagent including a primary (or secondary amine) and a tertiary amine to form amide bonds, followed by alkylation of the tertiary amine towards a quaternary ammonium functional group. An example of such a reagent is 3-(dimethylamino)-1-propylamine. Another reagent example is 3-(dimethylamino)-1-propanol or, more generally, a reagent that contains a hydroxyl group and a tertiary amine. The product of the described process is a charge control agent that contains two or more quaternary ammonium functional groups. Various alkylating agents can be used to form the quaternary ammonium functional groups. The quaternary ammonium functional groups may contain substituents that have one or more carbon-carbon double bonds, depending on the alkylating agent that is used. The cationic polymers that are produced by the processes described here have a molecular structure that can be generally represented by Formula V.

A typical color electro-optic display may have an electro-optic material layer that comprises an electrophoretic medium, which is encapsulated in microcapsules or microcells, as described in U.S. Pat. No. 6,982,178. FIG. 1 shows a side view of an example of the basic structure of a portion of a color electro-optic display having microcapsules. Color electro-optic display 100 comprises a first electrode layer 101 comprising a light transmissive electrode, an electro-optic material layer 102, a first adhesive layer 104, and a second electrode layer 103, the second electrode layer comprising a plurality of pixel electrodes. The first adhesive layer 104 connects the electro-optic material layer 102 with the second electrode layer. The electro-optic material layer 102 comprises a plurality of microcapsules 112. Each microcapsule has a microcapsule wall and includes electrophoretic medium 122 having charge pigment particles and a charge control agent in a non-polar liquid. Electrophoretic medium 122 comprises a plurality of first type of charged pigment particles and a plurality of second type of charged pigment particles. Electrophoretic medium may further comprise a plurality of third type of charged pigment particles. Electrophoretic medium 122 may further comprise a plurality of fourth type of charged pigment particles. Electrophoretic medium 122 may further comprise a plurality of fifth type of charged pigment particles. Typically, the plurality of microcapsules are retained within a polymeric binder 132. A viewer can view the image of display 100 from the viewing side 150. At least one type of charged pigment particles may comprise an organic pigment. The charge control agent has a molecular structure including two quaternary ammonium functional groups, two or more amide functional groups or two or more ester functional groups, and two or more aliphatic biradical units, each of the two or more aliphatic biradical units comprising a ring structure. Each of the two or more aliphatic biradical units may contain from 28 to 40 carbon atoms. The ring structure may comprise a six-member ring. The six-member ring may comprise a double bond. The six-member ring may comprise only carbon-carbon single bonds. The six-member ring may have four aliphatic substituents.

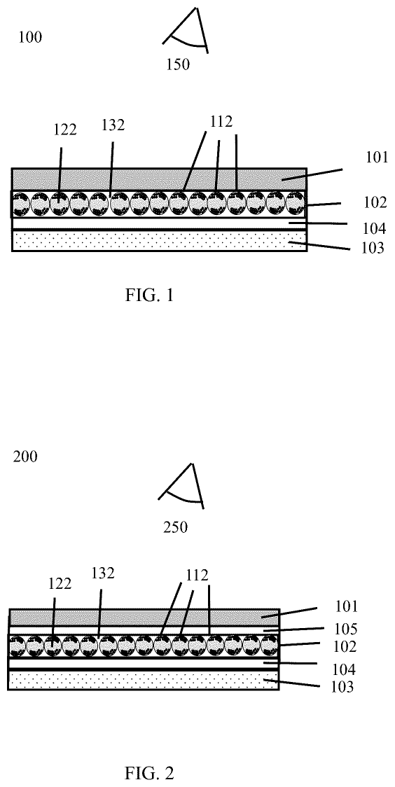

Another example of a color electro-optic display is shown in FIG. 2. FIG. 2 illustrates a side view of an example of the basic structure of a portion of a color electro-optic display having microcapsules. Electro-optic display 200 has a viewing side 150. It comprises, in order, a first electrode layer 101 comprising a light transmissive electrode, a second adhesive layer 105, an electro-optic material layer 102, a first adhesive layer 104, and a second electrode layer 103, comprising a plurality of pixel electrodes. The second adhesive layer 105 connects first electrode layer 101 with electro-optic material layer 102. The first adhesive layer 104 connects the electro-optic material layer 102 with the second electrode layer. The electro-optic material layer 102 comprises a plurality of microcapsules 112. Each microcapsule has a microcapsule wall and includes electrophoretic medium 122 having charge pigment particles and a charge control agent in a non-polar liquid. Electrophoretic medium 122 comprises a plurality of first type of charged pigment particles and a plurality of second type of charged pigment particles. Electrophoretic medium may further comprise a plurality of third type of charged pigment particles. Electrophoretic medium 122 may further comprise a plurality of fourth type of charged pigment particles. Electrophoretic medium 122 may further comprise a plurality of fifth type of charged pigment particles. The charge control agent has a molecular structure including two quaternary ammonium functional groups, two or more amide functional groups or two or more ester functional groups, and two or more aliphatic biradical units, each of the two or more aliphatic biradical units comprising a ring structure. Each of the two or more aliphatic biradical units may contain from 28 to 40 carbon atoms. The ring structure may comprise a six-member ring. The six-member ring may comprise a double bond. The six-member ring may comprise only carbon-carbon single bonds. The six-member ring may have four aliphatic substituents. Typically, the plurality of microcapsules are retained within a polymeric binder 132. The color electro-optic material layer 100 may be constructed from a double release sheet as described in the background of the invention.

The microcapsule color electro-optic displays of FIGS. 1 and 2 may further comprise a light transmissive front substrate (not shown in FIGS. 1 and 2), which is adjacent to the first electrode layer 101, wherein the electrode layer is disposed between the front substrate and the electro-optic material layer (for the display of FIG. 1) or between the front substrate and the second adhesive layer (for the display of FIG. 1). The front substrate may be a plastic film, such as a sheet of poly(ethylene terephthalate) (PET) having thickness of from 25 to 200 μm. Front substrate may further comprise one or more additional layers, for example, a protective layer to absorb ultraviolet radiation, barrier layers to prevent ingress of oxygen or moisture into the display, and anti-reflection coatings to improve the optical properties of the display.

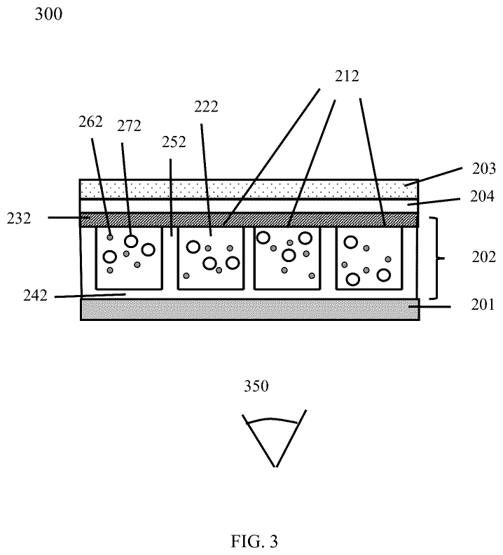

An example of a color electro-optic display that comprises microcells is illustrated in FIG. 3. Color electro-optic display 300 of FIG. 3 comprises, in order, a first electrode layer 201, an electro-optic material layer 202, an adhesive layer 204, and a second electrode layer 203, which comprises a plurality of pixel electrodes. Adhesive layer 204 connects sealing layer 232 of the electro-optic material layer 202 with second electrode layer 203 Electro-optic material layer 202 of color electro-optic display 300 comprises a plurality of microcells 212 and a sealing layer 232. Each microcell 212 of the plurality of microcells has a bottom 242, partition walls 252, and an opening, the sealing layer 232 spanning the opening of each microcell. Each microcell 212 of the plurality of microcells comprises electrophoretic medium 222. Electrophoretic medium 222 comprises a plurality of first type of charged pigment particles 272, a plurality of second type of charged pigment particles 262 and a charge control agent in a non-polar liquid. Electrophoretic medium 222 may further comprise a plurality of third type of charged pigment particles. Electrophoretic medium 222 may further comprise a plurality of fourth type of charged pigment particles. Electrophoretic medium 222 may further comprise a plurality of fifth type of charged pigment particles. The charge control agent. The charge control agent has a molecular structure including two quaternary ammonium functional groups, two or more amide functional groups or two or more ester functional groups, and two or more aliphatic biradical units, each of the two or more aliphatic biradical units comprising a ring structure. Each of the two or more aliphatic biradical units may contain from 28 to 40 carbon atoms. The ring structure may comprise a six-member ring. The six-member ring may comprise a double bond. The six-member ring may comprise only carbon-carbon single bonds. The six-member ring may have four aliphatic substituents. The color electro-optic material layer 100 may be constructed from a front plane laminate, as described in the background of the invention. A viewer can view the image of display 300 from the viewing side 350.

The microcell color electro-optic displays of FIG. 3 may further comprise a light transmissive front substrate (not shown in FIG. 3), which is adjacent to the first electrode layer 201, wherein the electrode layer is disposed between the front substrate and the electro-optic material layer. The front substrate may be a plastic film, such as a sheet of poly(ethylene terephthalate) (PET) having thickness of from 25 to 200 μm. Front substrate may further comprise one or more additional layers, for example, a protective layer to absorb ultraviolet radiation, barrier layers to prevent ingress of oxygen or moisture into the display, and anti-reflection coatings to improve the optical properties of the display.

In the electro-optic displays of FIGS. 1, 2, and 3, the first electrode layer may be a conductive layer having a thin continuous coating of electrically conductive material with minimal intrinsic absorption of electromagnetic radiation in the visible spectral range such as indium tin oxide (ITO), poly(3,4-ethylenedioxythiophene) poly(styrene sulfonate) (PEDOT:PSS), graphene or the like.

Microcells may be formed either in a batchwise process or in a continuous roll-to-roll process as disclosed in U.S. Pat. No. 6,933,098. The latter offers a continuous, low cost, high throughput manufacturing technology for production of compartments for use in a variety of applications including electro-optic display devices. Microcell arrays suitable for use with the invention can be created with microembossing.

### EXAMPLES

### Example of Preparation of Charge Control Agents

### Comparative Example 1

A charge control agent having polyricinoleic acid tail and a quaternary ammonium head was prepared using the process described as Example 1 of U.S. Patent Application Publication No. 2020/0355978A1. Ricinoleic acid monomer and 3-(dimethylamino)-1-propylamine reacted to form a polymer having polyricinoleic acid and an amine head. The amine was methylated with dimethyl sulfate to form charge control agent of Formula XXI, shown below, having weight average molecular weight of 9038 g/mol (CCA 111).

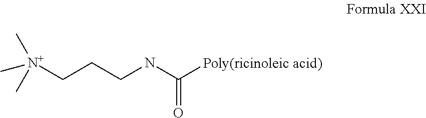

### Example 2

Polymerization: An amount of 22.72 g of Pripol™ 1009 was mixed with 62.1 g of Priplast™ 3238 and 15.4 g of toluene (15.4 grams) in a round bottom flask fitted with a mechanical stirrer, nitrogen inlet and a Dean-Stark trap. The mixture was heated under nitrogen to 175° C. under reflux for 3 hours and water was collected. The mixture was cooled to ambient temperature at which time an amount of 1.313 g of 3-(dimethylamino)-1-propylamine was added and the resulting mixture was heated to reflux to 200° C. for a total of 11.5 hours. Toluene was added or removed, as needed, in order to control the reflux temperature. After cooling, tin (II) octoate (0.1 grams) was added and the mixture refluxed for an additional 4 hours. The resulting polymeric mixture was isolated (117.2 grams), and the solids was measured to be 70.2%. Pripol™ 1009 (supplied by Cargill) is a dimer acid HOOC—X—COOH, wherein X is represented by the biradical unit of Formula II. Priplast™ 3238 (supplied by Cargill) is an amorphous polyester polyol with molecular weight of 2000 g/mol.

Quaternization: An amount of 86.50 g of the isolated polymeric mixture was mixed with 50.0 g of toluene and stirred under nitrogen. An amount of 1.107 g of dimethyl sulfate was added and the mixture was stirred at ambient temperature to complete the quaternization reaction. The product was vacuum stripped to remove volatiles yielding quaternized polymer. This type of quaternized polymer is generally represented by Formula V.

### Comparative Example 3

### Preparation of Electrophoretic Medium and Electro-Optic Displays

An electrophoretic medium was prepared using white, cyan, magenta, and yellow charged pigment particles, charge control agent from Comparative Example 1, and Isopar E. White charged pigment particles were negatively charged, whereas cyan, magenta, and yellow charged pigment particles were positively charged. The electrophoretic medium was used to prepare an electro-optic display illustrated in FIG. 3.

### Example 4

### Preparation of Electrophoretic Medium and Electro-Optic Displays

An electrophoretic medium was prepared using white, cyan, magenta, and yellow charged pigment particles, charge control agent from Example 2, and Isopar E. White charged pigment particles were negatively charged, whereas cyan, magenta, and yellow charged pigment particles were positively charged. The electrophoretic medium was used to prepare an electro-optic display illustrated in FIG. 3.

### Determination of Color Gamut of Electro-Optic Displays

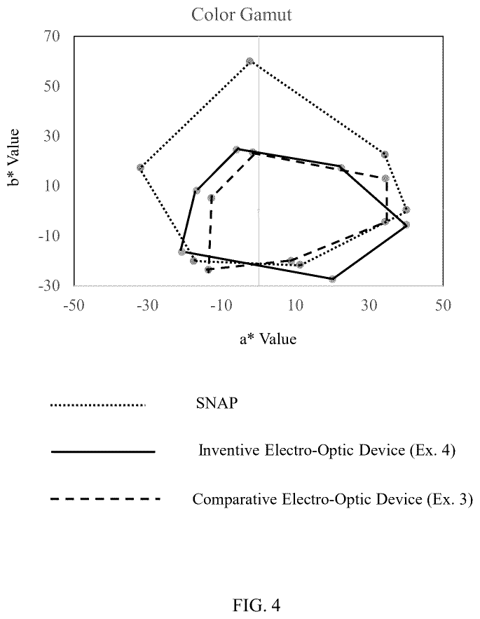

Each of the electro-optic displays from Comparative Example 3 and Example 4 was electrically driven to generate various optical states at 25° C., the reflection spectra of which were acquired using a spectrophotometer. CIE L*, a* and b* values of the reflected light from each electrophoretic display were measured. For each spectral sample, the minimum distance in L*a*b* space of the color of the display from each of the eight SNAP (Specifications for Newsprint Advertising Production) color standard primaries was calculated in units of ΔE*. The full color gamut from all measured points was also extracted. The primary colors were red, green, blue, yellow, cyan, magenta, white, and black (R, G, B, Y, C, M, W, and K). The lower the distance, the closer is the performance of the electrophoretic display to the SNAP target, indicating better color saturation of the optical state of the display. The results of color gamut of Inventive and Comparative Examples are summarized in FIG. 4. The solid line of figure corresponds to the gamut of inventive electro-optic display from Ex. 4 and the wide dotted line of the figure corresponds to the gamut of the Comparative electro-optic display form Ex. 3, wherein the narrow-dotted line of the figures corresponds to the color standard (SNAP).

It can be concluded from the color gamut graphs of FIG. 4 that the electrophoretic medium comprising the inventive charge control agent provided a broader total color gamut volume (58,100) compared to the system containing the control charge control agent (45,000).

It is likely that the improved performance of the inventive charge control agent is achieved because of the presence of (a) two cationic groups (quaternary ammonium groups) and (b) the branched alkyl groups in the molecular structure of the charge control agent. Such structures may provide reverse micelles with loops of branched hydrophobic groups on their surface, increasing the micelle stability in the non-polar liquid of the electrophoretic medium. Furthermore, the branched structure of the inventive charge control agent is expected to improve its solubility and its low temperature electro-optic performance even at low temperatures.

We claim:

1. An electrophoretic medium comprising a plurality of charged pigment particles, a charge control agent, and a non-polar liquid, the charge control agent having a molecular structure including two or more quaternary ammonium functional groups, two or more amide functional groups or two or more ester functional groups, and two or more aliphatic biradical units, each of the two or more aliphatic biradical units comprising a ring structure.

2. The electrophoretic medium of claim 1, wherein each of the two or more aliphatic biradical units contains from 28 to 40 carbon atoms.

3. The electrophoretic medium of claim 1, wherein the ring structure comprises a six-member ring.

4. The electrophoretic medium of claim 3, wherein the six-member ring comprises a double bond or wherein the six-member ring comprises only carbon-carbon single bonds.

5. The electrophoretic medium of claim 4, wherein the six-member ring has four aliphatic substituents.

6. The electrophoretic medium of claim 5, wherein a substituent of the six-member ring is an alkenyl group.

7. The electrophoretic medium of claim 1, wherein each of the two or more aliphatic biradical units is independently selected from the group consisting of molecular structures that are represented by Formula I and Formula II.

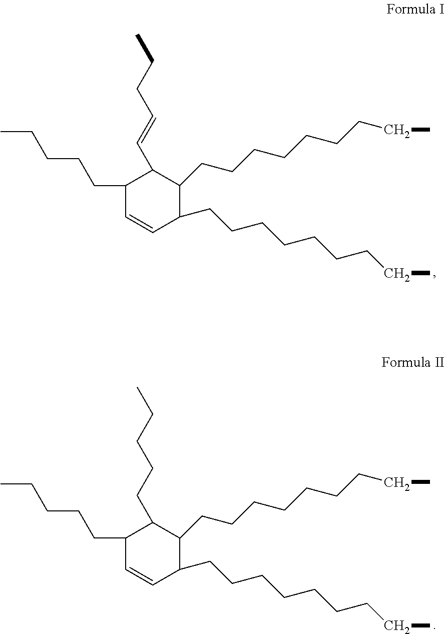

8. The electrophoretic medium of claim 7, wherein the molecular structure of the charge control agent comprises a group that is represented by Formula III,
wherein
each Q is independently selected from the group consisting of oxygen and NH group,
each —Z— is independently selected from the group consisting of an aliphatic biradical unit -A- and an aliphatic biradical unit —B—, -A- being represented by Formula I, and —B— being represented by Formula II, and
r is an integer from 1 to 20.

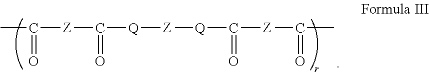

9. The electrophoretic medium of claim 7, wherein the molecular structure of the charge control agent is represented by Formula IV,
wherein
R1, R2, and R3 are independently selected by the group consisting of an alkyl, aryl, and alkenyl group,
each Q is independently selected from the group consisting of oxygen and NH group,
each —Z— is independently selected from the group consisting of an aliphatic biradical unit -A- and an aliphatic biradical unit —B—, -A- being represented by Formula I, and —B— being represented by Formula II, and
r is an integer from 1 to 20.

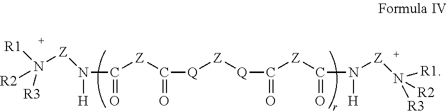

10. The electrophoretic medium of claim 7, wherein the molecular structure of the charge control agent is represented by Formula V,
wherein
R1, R2, and R3 are independently selected by the group consisting of alkyl, aryl, and alkenyl group,
each Q is independently selected from the group consisting of oxygen and NH,
each G is independently selected from the group consisting of oxygen, sulfur, and NH group,
D is —(CH₂)ₜ—, where t is an integer from 3 to 6,
each —Z— is independently selected from the group consisting of an aliphatic biradical unit -A- and an aliphatic biradical unit —B—, -A- being represented by Formula I, and —B— being represented by Formula II, and
r is an integer from 1 to 20.

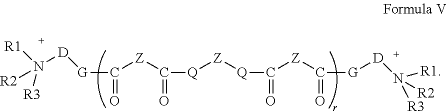

11. The electrophoretic medium of claim 10, wherein the molecular structure of the charge control agent is represented by Formula V, wherein R1, R2, R3 are methyl, G is oxygen or NH, Q is oxygen, D is —(CH₂)₃—, and —Z— is an aliphatic biradical unit that is represented by Formula I.

12. The electrophoretic medium of claim 7, wherein the molecular structure of the charge control agent is represented by Formula VI,
wherein
R1, R2, and R3 are independently selected by the group consisting of alkyl, aryl, and alkenyl group,
each Q is independently selected from the group consisting of oxygen and NH group,
each —Z— is independently selected from the group consisting of an aliphatic biradical unit -A- and an aliphatic biradical unit —B—, -A- being represented by Formula I, and —B— being represented by Formula II, and
r is an integer from 1 to 20.

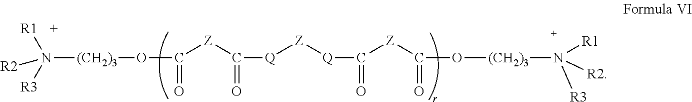

13. The electrophoretic medium of claim 1 comprising a plurality of first, second, and third types of charged pigment particles, wherein each type of charged pigment particles has different color from each other type of charged pigment particles.

14. The electrophoretic medium of claim 1, wherein the charge control agent has a weight average molecular weight greater than or equal to 1000 g/mol.

15. The electrophoretic medium of claim 1, wherein the charge control agent has a weight average molecular weight from 1000 g/mol to 8,000 g/mol.

16. The electrophoretic medium of claim 1, further comprising a second charge control agent, wherein the second charge control agent comprises a hydrophobic moiety and a head group selected from the group comprising an anionic functional group, a nonionic functional group, and a cationic functional group.

17. The electrophoretic medium of claim 1, wherein the plurality of charged pigment particles are capable of moving through the non-polar liquid upon application of an electric field.

18. An electro-optic display comprising a light transmissive, electrically-conductive layer, an electro-optic material layer, and a substrate comprising a plurality of pixel electrodes, wherein the electro-optic material layer comprises the electrophoretic medium of claim 1.

19. The electro-optic display of claim 18, wherein the electrophoretic medium is encapsulated in a plurality of microcapsules or in a plurality of microcells.

20. The electro-optic display of claim 19, wherein each of the plurality of microcells includes a bottom layer, partition walls, an opening, and a sealing layer, the sealing layer spanning the opening of each microcell.
